(19) United States
(12) Patent Application Publication
(10) Pub. No.: US 2010/0028023 A1
(43) Pub. Date: Feb. 4, 2010

(54) OPTICAL RECEIVER

(75) Inventor: Atsunobu Ohta, Musashino-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/533,430

(22) Filed: Jul. 31, 2009

(30) Foreign Application Priority Data
Aug. 1, 2008 (JP) 2008-199137

(51) Int. Cl. H04B 10/06

(52) U.S. Cl. 398/213

(57) ABSTRACT

There is provided an optical receiver capable of coping with a balanced optical input, and having neither the need for adjustment of the reference voltage for single-differential conversion, nor the need for a large-capacitance capacitor corresponding to a wideband signal, for connecting the output of the trans-impedance amp to the input of the limiter amp. The optical receiver comprises a balanced photodiode composed of two units of light-sensitive elements connected in series in the direction of an identical polarity, having a bidirectional current, a differential amplifier comprising differential input pair-transistors, an emitter follower section for causing respective output signals of the differential amplifier to undergo level shift, feedback resistance for feeding back output signals of the emitter follower section to respective input terminals of the differential amplifier, and a capacitor coupled to the base of the other transistor of the differential input pair-transistors.

### FIELD OF THE INVENTION

The present invention relates to an optical receiver, and more specifically, to an optical receiver capable of delivering differential output by coping with a phase modulation scheme expected to be used in next-generation optical communication, employing a balanced photodiode composed of 2 units of photodiodes that are monolithic-integrated.

### BACKGROUND OF THE INVENTION

FIG. 8 is a block diagram showing an example of a conventional optical receiver using a trans-impedance amp. The optical receiver comprises one unit of a photodiode 1 for receiving an optical signal, a trans-impedance amp 2 for linearly amplifying an electric signal converted from the optical signal received by the photodiode 1, a large-capacitance capacitor 3 capable of allowing a signal having a wideband frequency to pass by cutting off a direct current, two units of bias generators 4a, 4b, and a differential limiter amp 5 for receiving a predetermined dc voltage from those bias generators 4a, 4b so as to undergo an adequate operation, and amplifying a small signal output amplified by the trans-impedance amp 2 until limited to a given output amplitude.

FIG. 9 is a specific circuit diagram of the optical receiver shown in the block diagram of FIG. 8. In FIG. 9, the trans-impedance amp 2 is composed of an amplifier 21, an emitter follower 22, and a feedback resistance 23. An output of the photodiode 1 is delivered to the base of the amplifier 21, the collector of the amplifier 21 is connected to the base of the emitter follower 22, and the emitter of the emitter follower 22 is connected to the base of the amplifier 21 via the feedback resistance 23, while the emitter is also coupled to the limiter amp 5 via another amplifier and the capacitor 3.

The limiter amp 5 comprises a differential amplifier 51, and an emitter follower section 52 composed of two systems of emitter followers. The capacitor 3, together with the bias generator 4a, is coupled to one base of differential inputs in pairs, constituting the differential amplifier 51, while the bias generator 4b is connected to the other base of the differential inputs in pairs, and a bias generator 4c for adjustment of a current from a current source is connected to the base of a transistor connected in series to the differential inputs in pairs, on a side of the differential amplifier 51, adjacent to a current source.

One collector of the differential inputs in pairs is connected to the base of one of the emitter followers of the emitter follower section 52, and the other collector of the differential inputs in pairs is connected to the base of the other emitter follower of the emitter follower 52. An output terminal Out is connected to the emitter of the one emitter follower of the emitter follower 52, and an output terminal Out B is connected to the emitter of the other emitter follower of the emitter follower 52.

With such a configuration as described, a portion of an output of the emitter follower 22 is fed back to an input terminal of the trans-impedance amp 2 via the feedback resistance 23, so that a feedback signal gives an optimum advice to input transistors of the trans-impedance amp 2. This circuit is in use on the premise of an operation for causing a current to flow from the photodiode 1 toward the trans-impedance amp 2 (in the direction of current sink).

Patent Document 1 relates to an optical receiver capable of fast drawing in a reference voltage in single-balance conversion, and improving an output duty ratio close to an ideal ratio 50%.

[Patent Document 1] JP 2003-51723 A

### SUMMARY OF THE INVENTION

However, since the conventional optical receiver shown in FIG. 8 is based on an intensity modulation scheme, the optical receiver has a problem that it is unable to cope with a balanced photodetector employing two units of light-sensitive elements having a current flowing in the direction of current sink toward the trans-impedance amp, and a current flowing in the direction of a current source from the trans-impedance amp, respectively.

Further, the optical receiver has other problems including a problem that in order to connect an output of the trans-impedance amp 2 to the differential amplifier 51 of the limiter amp 5, having the differential inputs, there will arise the need for single-differential amplification conversion, and another problem that there will arise the need for the capacitor 3 having a large capacitance for coping with a wideband signal, in order to connect the output of the trans-impedance amp 2 with an input of the limiter amp 5.

Furthermore, a further problem exists in that in order to stably maintain a duty ratio (a cross point) of an output signal from the differential amplifier 51, there will arise the need for highly accurate adjustment of the reference voltage for the differential inputs in pairs, using an external circuit and so forth.

The present invention is intended to solve those problems described as above, and it is an object of the invention to provide an optical receiver capable of coping with a balanced optical input, and having neither the need for adjustment of the reference voltage for single-differential conversion, nor the need for a large-capacitance capacitor corresponding to a wideband signal, for connecting the output of the trans-impedance amp to the input of the limiter amp.

To that end, in accordance with one aspect of the invention, there is provided an optical receiver comprising a balanced photodiode composed of two units of light-sensitive elements connected in series in the direction of an identical polarity, having a bidirectional current, a differential amplifier comprising differential input pair-transistors, an output signal of the balanced photodiode being delivered to the base of one transistor of the differential input pair-transistors, an emitter follower section for causing respective output signals of the differential amplifier to undergo level shift, feedback resistance for feeding back output signals of the emitter follower section to respective input terminals of the differential amplifier, and a capacitor coupled to the base of the other transistor of the differential input pair-transistors.

An optical signal may fall on either of the light-sensitive elements of the balanced photodiode.

The optical receiver preferably further comprises a compensating circuit connected to output terminals of the emitter follower section, for compensating for a cross point of each of output signals from the emitter follower section.

Respective circuits may be made up of a monolithic integrated circuit.

Each of the transistors is preferably an field effect transistor (FET).

With adoption of such a configuration as described above, it is possible to implement the optical receiver capable of coping with a balanced optical input, and having neither the need for adjustment of the reference voltage for single-differential conversion, nor the need for a large-capacitance capacitor corresponding to a wideband signal, for connecting the output of the trans-impedance amp to the input of the limiter amp.

### BRIEF DESCRIPTION OF THE DRAWINGS

FIG. 1 is a block diagram showing one embodiment of an optical receiver according to the present invention;

FIG. 2 is a circuit diagram of the optical receiver according to the embodiment of the present invention;

FIG. 3 is a view showing an example of a balanced current input waveform according to the present invention;

FIG. 4 is a view showing another example of a balanced current input waveform according to the present invention;

FIG. 5 is a view showing an example of a receiver output waveform corresponding to balanced input according to the present invention;

FIG. 6 is a view showing an example of an output waveform of demodulated received data according to the present invention;

FIG. 7 is a view showing an example of a receiver output waveform according to the present invention;

FIG. 8 is a block diagram showing an example of a conventional optical receiver; and

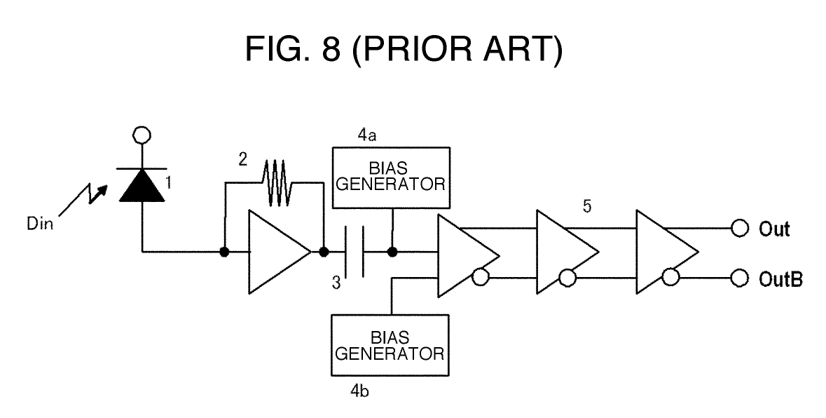

FIG. 9 is a circuit diagram of the optical receiver shown in FIG. 8.

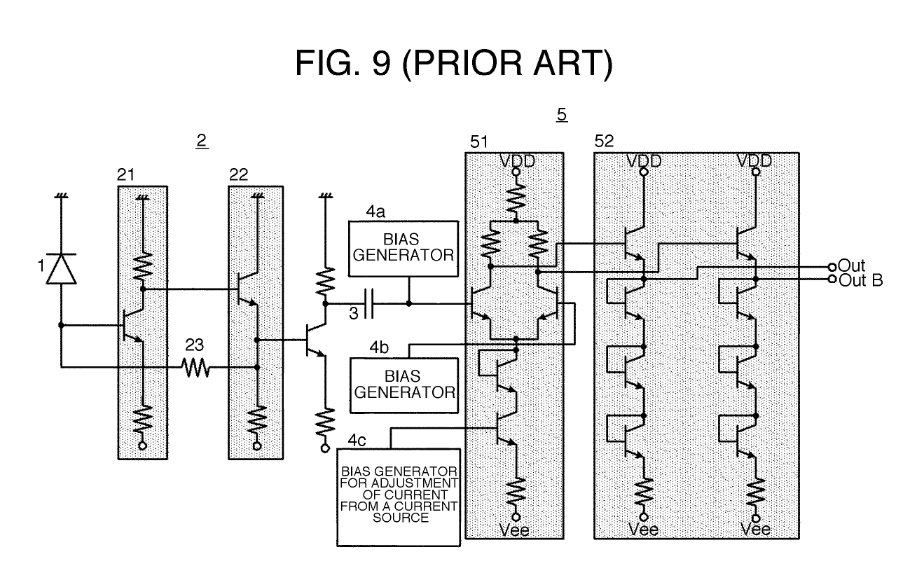

### DETAILED DESCRIPTION OF THE PREFERRED EMBODIMENTS

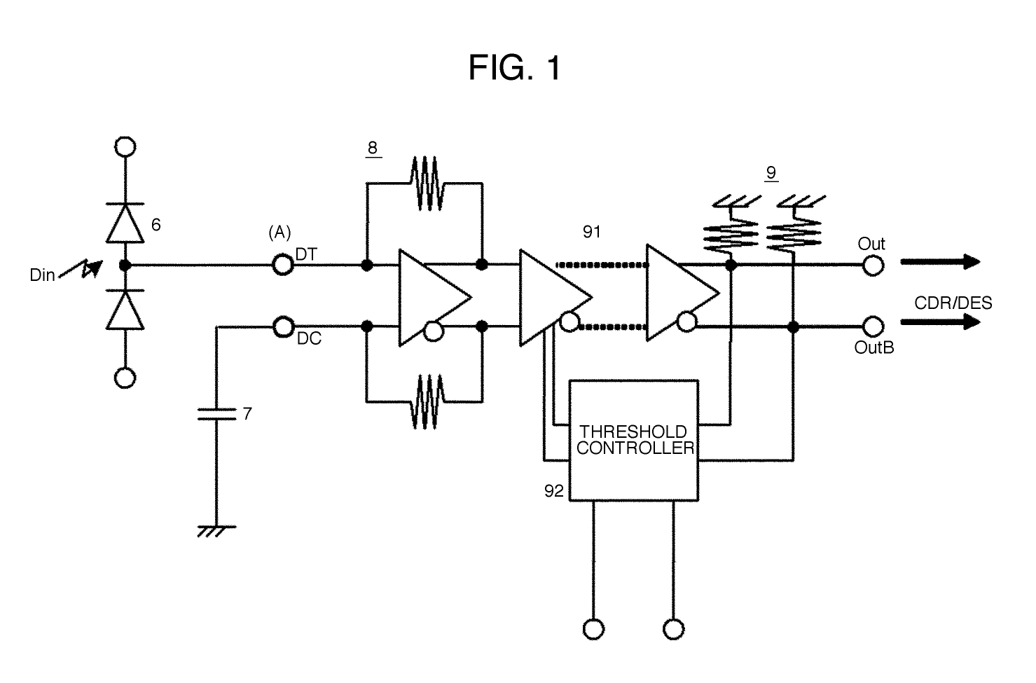

An optical receiver according to the invention is described hereinafter with reference to the accompanying drawings. FIG. 1 is a block diagram showing one embodiment of an optical receiver according to the invention. The optical receiver according to the invention comprises a balanced photodiode 6 composed of two units of light-sensitive elements connected in series in the direction of an identical polarity, having a bidirectional current, a capacitor 7 for stabilizing a reference voltage, a differential trans-impedance circuit 8, and a compensating circuit 9.

### Embodiment 1

A power supply voltage is applied to respective ends of the balanced photodiode 6, and a node at the mid point of connection between the respective ends is connected to an input terminal of the differential trans-impedance circuit 8, on the DT side thereof. An input terminal of the differential trans-impedance circuit 8, on the DC side thereof, is grounded, and a reference voltage as stabilized by the capacitor 7 is inputted thereto. The compensating circuit 9 comprises a limiter amp 91, a threshold controller 92 for controlling a limit operation range of the limiter amp 91, and an output cross-point compensating circuit (not shown).

The balanced photodiode 6 converts received optical input data Din into an electrical signal (a current) to be delivered to the DT side of the differential trans-impedance circuit 8. The reference voltage as stabilized by the capacitor 7 has been delivered to the input terminal of the differential trans-impedance circuit 8, on the DC side thereof. As a result, the electrical signal outputted from the balanced photodiode 6 after conversion is linearly amplified by the differential trans-impedance circuit 8 to be delivered to the limiter amp 91. The limiter amp 91 amplifies the electrical signal so as to be at a given output amplitude up to a limit operation range controlled by the threshold controller 92.

Herein, since one of differential inputs in the differential trans-impedance circuit 8 is provided with the capacitor 7, it is possible to make adjustment of the reference voltage for single-differential conversion, corresponding to a balanced optical input.

Further, in contrast to the case of the conventional optical receiver wherein one unit of the photodiode 1 is in use, and a current flows only in one direction, with the optical receiver according to the present embodiment of the invention, use is made of the balanced photodiode 6 composed of 2 units of the light-sensitive elements connected in series in the direction of the identical polarity, so that it is possible to cause a current to flow from a point A in FIG. 1 in both the direction of current sink, and the direction of a current source.

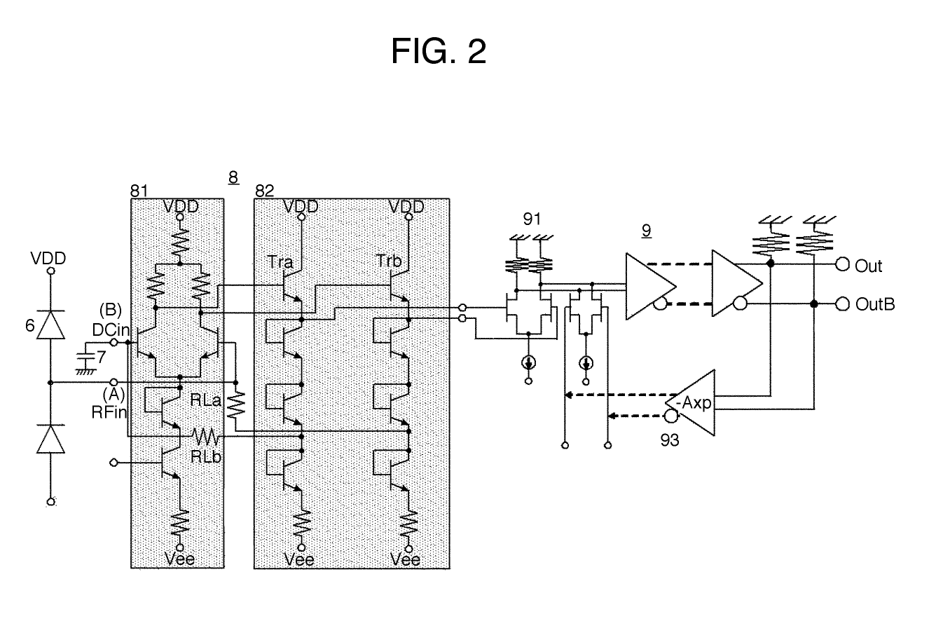

FIG. 2 is a specific circuit diagram of the optical receiver shown in the block diagram of FIG. 1. In FIG. 2, the differential trans-impedance circuit 8 comprises a differential amplifier 81, and an emitter follower section 82. The compensating circuit 9 comprises the limiter amp 91, and the output cross-point compensating circuit 93. The threshold controller 92 is not shown in FIG. 2.

In the differential trans-impedance circuit 8, the differential amplifier 81 comprises differential input pair-transistors having a common emitter, and the base of one transistor of the differential input pair-transistors is connected to an input terminal (A), to which a current converted from the optical input as received by the balanced photodiode 6 is inputted, while the base of the other transistor of the differential input pair-transistors is connected to an input terminal (B), so as to be stabilized by the capacitor 7, functioning as a reference signal pairing up with the input terminal (A).

On the other hand, the emitter follower section 82 is composed of two systems of emitter followers, and a current flows therethrough upon application of the power supply voltage VDD to the respective collectors of transistors Tra, and Trb. The respective emitter followers are connected to the input terminal (A), and the input terminal (B) of the differential trans-impedance circuit 8 via load resistances RLa, and RLb, respectively, and input circuits of the differential trans-impedance circuit 8 are structured so as to be symmetrical with each other.

The compensating circuit 9 is capable of raising a duty ratio (the cross point) of an output signal to 50% by making adjustment of a potential difference.

More specifically, installation of the capacitor 7 enables adjustment of the reference voltage for single-differential conversion, corresponding to a balanced optical input. Further, feedback resistances and the capacitor 7 have a function of an automatic offset-adjust circuit.

That is, since DC voltages activating the respective emitter followers of the emitter follower section 82 are equal, a voltage at the input terminal (B) can always act as an optimized reference voltage against a signal of the input terminal (A).

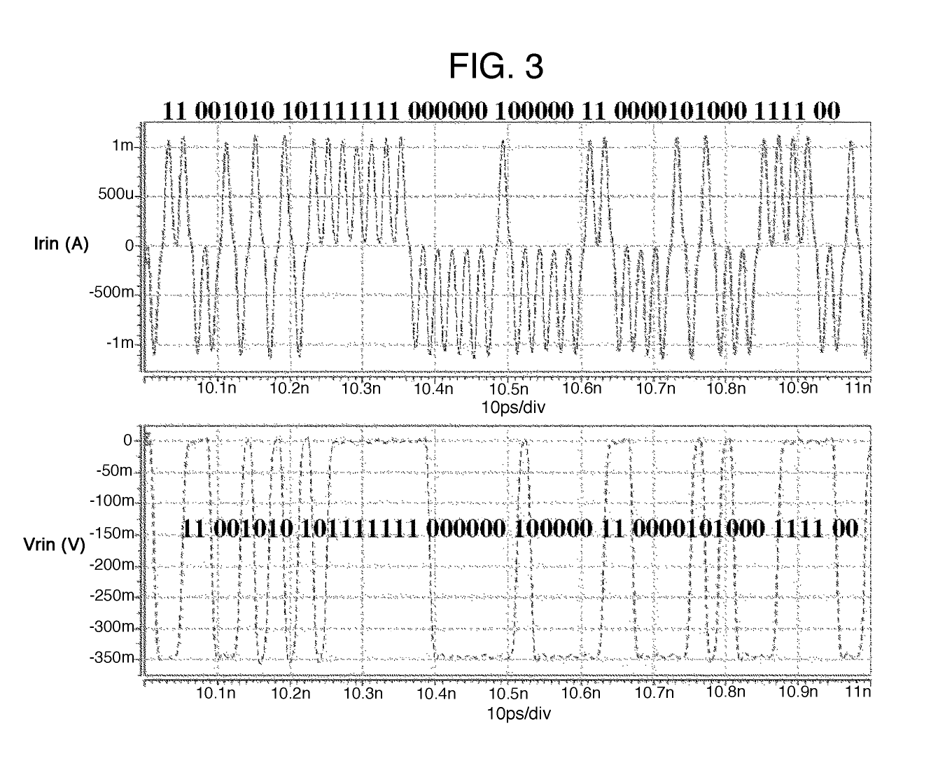

FIG. 3 is a schematic representation showing an example of demodulated data on a receiver output corresponding to a balanced input waveform. It can be confirmed from a balanced input signal waveform Irin (A) that a current at the point (A) in FIG. 1 flows in the directions of respective polarities. Further, if a limiter output waveform Vrin (V) by use of the compensating circuit 9 is superimposed on the former, a waveform will be turned “0”, outputting a given value. That is, it can be confirmed from those waveforms that the balanced photodiode 6 alternately receives an optical input due to balanced input.

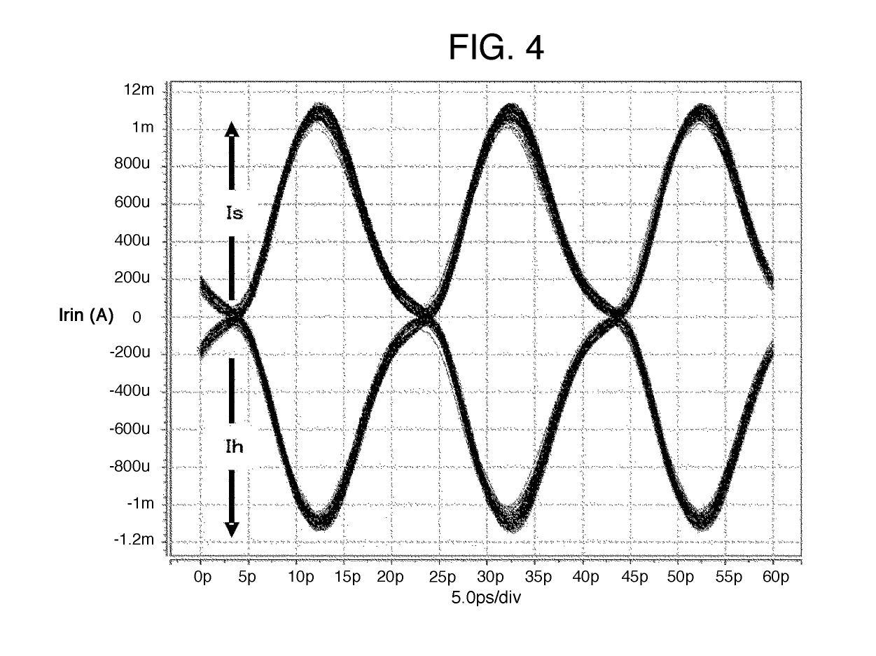

FIG. 4 is a view showing an example of a balanced current input waveform Irin (A) according to the present invention. It can be confirmed from those waveforms that a current flows in the directions of the respective polarities, that is, the direction of current sink (Is), and the direction of current source (Ih).

Since the balanced photodiode 6 alternately receives an optical input due to such balanced input, it is possible to gain amplitude twice as large as that in the past.

Upon amplification of an input signal by the differential trans-impedance circuit 8, the input signal is subjected to single-balance conversion, and further, the emitter follower section 82 executes impedance conversion, and level shift. As a portion of an output of the emitter follower section 82 is fed back to an input terminal of the differential trans-impedance circuit 8 via the feedback resistance, it is possible to implement an increase in signal bandwidth.

Further, an operating point (a mean voltage value) at the point (A) in FIG. 1 will be a DC operating point in the emitter follower section 82 of the differential trans-impedance circuit 8. In other words, without flow of DC due to the balanced input, the operating point inside the circuit, as it is, will serve as the operating point.

Then, with a point (B) in FIG. 2, an operating point is extracted on the basis of an output of the emitter follower section 82 pairing up with the transistors. Furthermore, with the point (B) in FIG. 2, such a capacitance value as to render impedance sufficiently small within a signal frequency range at the point (A) is selected, thereby attaining wideband stabilization.

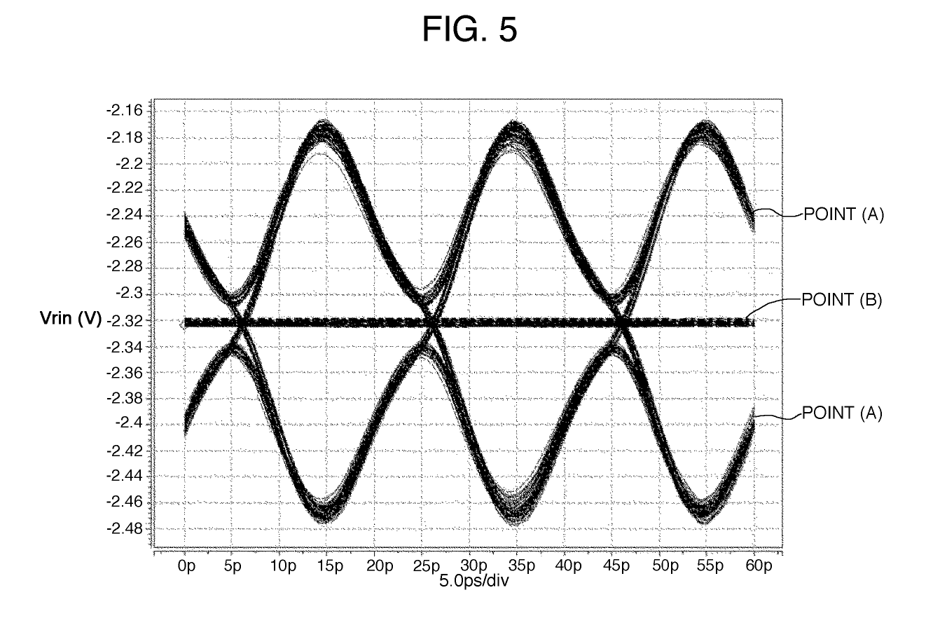

FIG. 5 is a waveform chart showing an example of a balanced voltage input waveform Vrin (V). It can be confirmed that a reference voltage at the point (B) in FIG. 2 is in operation as the center point for identification against a signal at the point (A) in FIG. 2 regardless of an input signal current. That is, it can be confirmed that the given value is always taken at the point (B) in FIG. 2 without input adjustment.

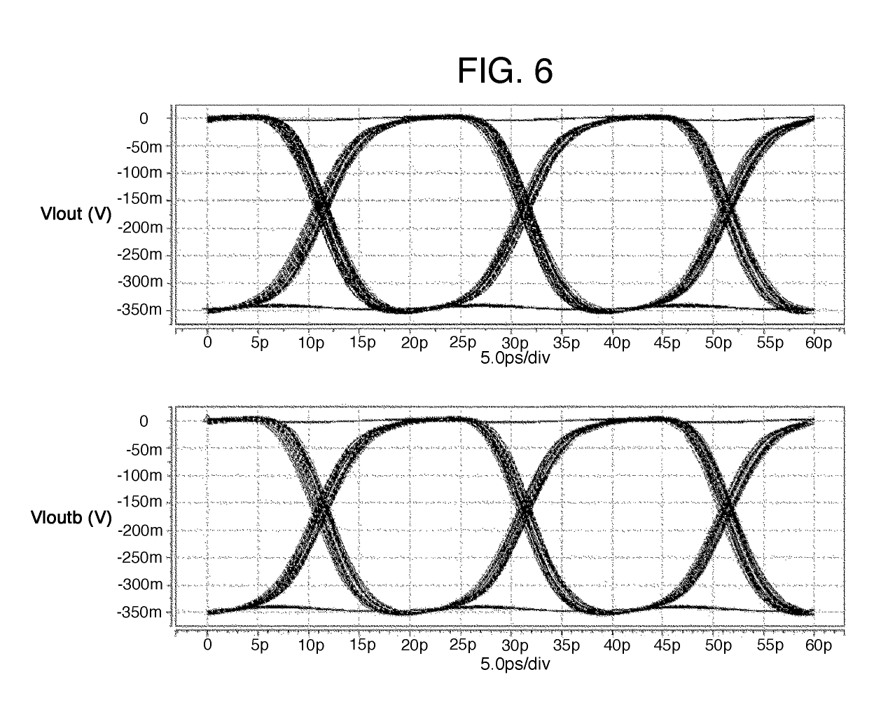

FIG. 6 is a view showing an example of an output waveform of demodulated received data. It can be confirmed from observation of respective waveforms Vlout (V), and Vloutb (V) that an output signal has a duty ratio close to 50% as the ideal ratio. That is, with the use of a circuit of the optical receiver shown in FIG. 1, the duty ratio (the cross point) of the output signal can be improved to 50% at the ideal value, thereby improving a minimum optical receiving sensitivity of the optical receiver.

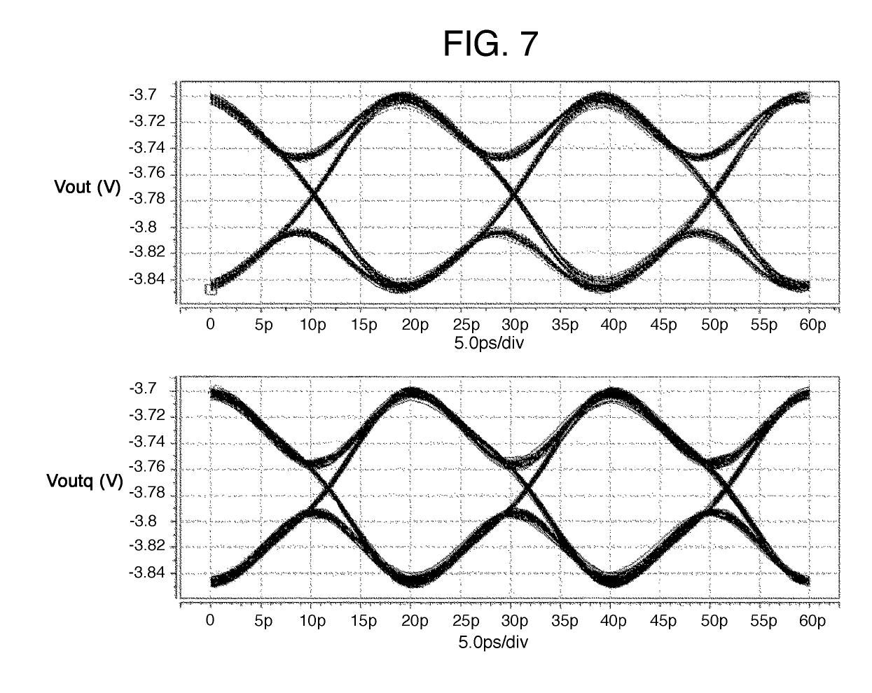

FIG. 7 is a view showing an example of an output waveform to an output monitor of a differential trans-impedance circuit 80. It can be confirmed from observation of waveforms Vout (V), Voutq (V) that a limiter circuit amplifies a monitor waveform signal until a signal level of saturation operation is reached.

Further, the present invention is applicable not only to a bipolar transistor (junction-type transistor) but also to an integrated circuit using an FET (field effect transistor).

Furthermore, the balanced photodiode may be made up of a monolithic integrated circuit.

As described in the foregoing, with the present invention, use is made the balanced photodiode 6 in place of the conventional photodiode 1, and use is made of the capacitor 7 for stabilizing the reference voltage. By so doing, it is possible to provide an optical receiver capable of coping with the balanced optical input, and having neither the need for adjustment of the reference voltage for single-differential conversion, nor the need for a large-capacitance capacitor corresponding to a wideband signal, for connecting the output of the trans-impedance amp 2 to the input of the limiter amp.

What is claimed is:

1. An optical receiver comprising a balanced photodiode composed of two units of light-sensitive elements connected in series in the direction of an identical polarity, having a bidirectional current;
a differential amplifier comprising differential input pair-transistors, an output signal of the balanced photodiode being delivered to the base of one transistor of the differential input pair-transistors;
an emitter follower section for causing respective output signals of the differential amplifier to undergo level shift;
feedback resistance for feeding back output signals of the emitter follower section to respective input terminals of the differential amplifier; and
a capacitor coupled to the base of the other transistor of the differential input pair-transistors.

2. The optical receiver according to claim 1, wherein an optical signal falls on either of the light-sensitive elements of the balanced photodiode.

3. The optical receiver according to claim 1, further comprising a compensating circuit connected to output terminals of the emitter follower section, for compensating for a cross point of each of output signals from the emitter follower section.

4. The optical receiver according to claim 1, wherein respective circuits are made up of a monolithic integrated circuit.

5. The optical receiver according to claim 1, wherein each of the respective transistors is a field effect transistor (FET).
